(19) United States
(12) Patent Application Publication
(10) Pub. No.: US 2025/0124528 A1
(43) Pub. Date: Apr. 17, 2025

(54) INTELLIGENT SOLAR POWER GENERATION AND DISTRIBUTION SYSTEM USING DIGITAL TWIN

(71) Applicant: NEC Laboratories America, Inc., Princeton, NJ (US)

(72) Inventors: Yangmin DING, East Brunswick, NJ (US); Ting WANG, West Windsor, NJ (US); Zhuocheng JIANG, Plainsboro, NJ (US); Yue TIAN, Princeton, NJ (US); Sarper OZHARAR, Pennington, NJ (US)

(73) Assignee: NEC Laboratories America, Inc., Princeton, NJ (US)

(21) Appl. No.: 18/901,664

(22) Filed: Sep. 30, 2024

Related U.S. Application Data
(60) Provisional application No. 63/543,977, filed on Oct. 13, 2023.
(60) Provisional application No. 63/591,164, filed on Oct. 18, 2023.

(51) Int. Cl. G06Q 50/06; H02J 3/00; H02S 50/00

(52) U.S. Cl. CPC G06Q 50/06; H02J 3/004; H02S 50/00; H02J 2203/20; H02J 2300/26

(57) ABSTRACT

Disclosed are twin-based systems and methods for predicting solar power generation and optimizing power generation and distribution processes. Employed are a digital twin model of a solar power plant, which includes detailed representations of various components, such as solar panels, inverters, and transformers, as well as real-time weather data and historical data. This advantageously allows for accurate simulations of plant performance under various weather conditions and operational scenarios. Our systems and methods Incorporate novel machine learning algorithms that are trained on historical and real-time data from the digital twin model, weather data, solar power generation data, and other relevant factors. These algorithms utilize an advanced ensemble learning approach, which combines multiple predictive models, such as deep learning, support vector machines, and decision trees, to achieve higher accuracy and robustness in predicting solar power generation

### CROSS-REFERENCE TO RELATED APPLICATIONS

This application claims the benefit of U.S. Provisional Patent Application Ser. No. 63/543,977 filed Oct. 13, 2023, and U.S. Provisional Patent Application Ser. No. 63/591,164 filed Oct. 18, 2023, the entire contents of each of which is incorporated by reference as if set forth at length herein.

### FIELD OF THE INVENTION

This application relates generally to power generation and distribution. More particularly, it pertains to intelligent power generation and distribution using digital twin.

### BACKGROUND OF THE INVENTION

Solar power plants are subject to variability in power generation due to weather conditions, temperature changes, and other factors. Thus, electricity generation from solar sources is weather-dependent. FIG. 1 shows typical patterns for U.S.-based electricity generators using solar energy. As we see from the figure, over the course of a typical day, generation from any individual solar source peaks in the early afternoon. Over the course of a year, generation from any individual solar generator typically peaks in summer. This variability can lead to inefficient use of power resources and unstable power delivery to users. As such, there is a continuing need for systems and methods that can accurately predict solar power generation and optimize power generation and distribution processes.

### SUMMARY OF THE INVENTION

An advance in the art is made according to aspects of the present disclosure directed to innovative twin-based systems and methods for predicting solar power generation and optimizing power generation and distribution processes.

In sharp contrast to the prior art, our inventive systems and methods according to the present disclosure utilize a digital twin model of a solar power plant, which includes detailed representations of various components, such as solar panels, inverters, and transformers, as well as real-time weather data and historical data. This advantageously allows for accurate simulations of plant performance under various weather conditions and operational scenarios.

Our inventive systems and methods according to the present disclosure incorporate novel machine learning algorithms that are trained on historical and real-time data from the digital twin model, weather data, solar power generation data, and other relevant factors. These algorithms utilize an advanced ensemble learning approach, which combines multiple predictive models, such as deep learning, support vector machines, and decision trees, to achieve higher accuracy and robustness in predicting solar power generation

Additionally, our inventive systems and methods integrate advanced weather forecasting to provide more accurate predictions of solar power generation. This allows our systems and methods to adjust energy storage levels and improve power grid stability by routing energy from solar generators to areas where it is needed most, adjusting to fluctuations in solar power generation.

As will become apparent to those skilled in the art, the present disclosure describes intelligent and efficient systems and methods for solar power generation and distribution that utilizes advanced technologies to accurately predict solar power generation, optimize energy storage, and improve power grid stability.

Additional aspects of the present disclosure worth noting include the following.

### Digital Twin Model

The digital twin model is a virtual representation of the solar power plant, including solar panels, inverters, transformers, and other associated equipment. The digital twin model is updated in real-time with sensor data from the actual solar power plant, allowing for accurate simulations of plant performance under various weather conditions and operational scenarios

Our digital twin model incorporates a unique combination of weather data, equipment performance data, and maintenance schedules to simulate the solar power plant. This allows for a comprehensive understanding of the plant's performance and enables more accurate predictions of solar power generation.

### Machine Learning Algorithm

The machine learning algorithm is an advanced predictive model trained on historical and real-time data from the digital twin model, weather data, solar power generation data, and other relevant factors. The algorithm is designed to adapt to changing conditions and continuously learn from new data to improve its accuracy and efficiency in predicting solar power generation.

Our machine learning algorithm incorporates a novel ensemble learning approach, combining multiple predictive models, such as deep learning, support vector machines, and decision trees, to achieve higher accuracy and robustness in predicting solar power generation. This innovative approach allows the algorithm to adapt to various weather conditions and operational scenarios, providing a more accurate prediction of solar power generation and enabling better optimization of power resources.

### Optimization of Power Generation and Distribution Processes

The digital twin model and machine learning algorithm work together to optimize power generation and distribution processes. The algorithm predicts solar power generation and identifies potential inefficiencies, allowing for adjustments in the digital twin model to improve plant performance. The system can also optimize power distribution by routing energy from solar generators to areas where it is needed most, adjusting to fluctuations in solar power generation.

This optimization of power generation and distribution processes is a novel aspect of the present invention, as it provides an efficient and intelligent approach to managing solar power generation and distribution. The system's ability to predict and adjust to fluctuations in solar power generation, coupled with its energy storage optimization, ensures that the solar power plant is running at maximum efficiency, resulting in a more reliable and sustainable power system.

### Integration with Energy Storage Systems and Demand Response Programs

The digital twin model and machine learning algorithm can be integrated with energy storage systems, such as batteries or pumped hydro storage, to help stabilize power delivery by storing excess energy generated during peak solar production periods and releasing it during periods of low solar output. This integration allows for more efficient use of solar power and helps to mitigate the effects of solar power variability on the grid.

Additionally, the system can be integrated with demand response programs that incentivize users to adjust their power consumption based on real-time solar power generation. By encouraging users to shift their energy use to periods of high solar power generation, demand response programs can help optimize the distribution of power, reduce the need for additional power sources, and better balance supply and demand on the grid.

By integrating with energy storage systems, such as batteries or pumped hydro storage, the system can help stabilize power delivery by storing excess energy generated during peak solar production periods and releasing it during periods of low solar output. This integration allows for more efficient use of solar power and helps to mitigate the effects of solar power variability on the grid. The integration with demand response programs is another innovative feature of the present invention. Demand response programs allow for the system to automatically adjust power usage during periods of high demand or low supply, helping to reduce strain on the power grid and ensuring a stable supply of electricity. The digital twin model and machine learning algorithm can predict future demand and supply trends, allowing for optimal use of energy storage systems and more efficient management of power generation and distribution.

The combination of the digital twin model, machine learning algorithm, energy storage systems, and demand response programs provides a comprehensive solution to address the challenges posed by the variability of solar power generation, leading to more efficient use of power resources and stable power delivery to users.

### BRIEF DESCRIPTION OF THE DRAWING

FIG. 1 shows a pair of plots illustrating generation patterns for U.S. solar source;

FIG. 2(A), FIG. 2(B), FIG. 2(C), FIG. 2(D), FIG. 2(E), and FIG. 2(F) are a series of schematic flow diagrams showing an illustrative overall method for optimizing power generation and distribution according to aspects of the present disclosure.

FIG. 3 is a schematic flow diagram showing an illustrative method for collecting real-time sensor data according to aspects of the present disclosure;

FIG. 4 is a schematic flow diagram showing an illustrative method for collecting historical data according to aspects of the present disclosure;

FIG. 5 is a schematic flow diagram showing an illustrative method for monitoring real-time data according to aspects of the present disclosure;

FIG. 6 is a schematic flow diagram showing an illustrative method for gathering simulation inputs and running same according to aspects of the present disclosure;

FIG. 7 is a schematic flow diagram showing an illustrative method for generating solar power predictions and optimizing power generation according to aspects of the present disclosure;

FIG. 8 is a schematic flow diagram showing an illustrative method for integrating energy with energy storage systems and demand response programs according to aspects of the present disclosure;

FIG. 9 is a schematic feature diagram showing illustrative features of systems and methods according to aspects of the present disclosure;

FIG. 10 is a schematic flow diagram showing an illustrative method for integrating distributed fiber optic sensing (DFOS) into our inventive systems and methods data according to aspects of the present disclosure;

FIG. 11 is a schematic flow diagram showing an illustrative method for weather forecasting for systems and methods according to aspects of the present disclosure;

FIG. 12 is a schematic flow diagram showing an illustrative method for DFOS data preprocessing for systems and methods according to aspects of the present disclosure;

FIG. 13 is a schematic flow diagram showing an illustrative method for temporal and spatial alignment for systems and methods according to aspects of the present disclosure;

FIG. 14 is a schematic flow diagram showing an illustrative weighted data fusion method for systems and methods according to aspects of the present disclosure;

FIG. 15 is a schematic block diagram showing an illustrative arrangement of a system according to aspects of the present disclosure;

FIG. 16(A) and FIG. 16(B) are schematic diagrams showing an illustrative prior art uncoded and coded DFOS systems.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

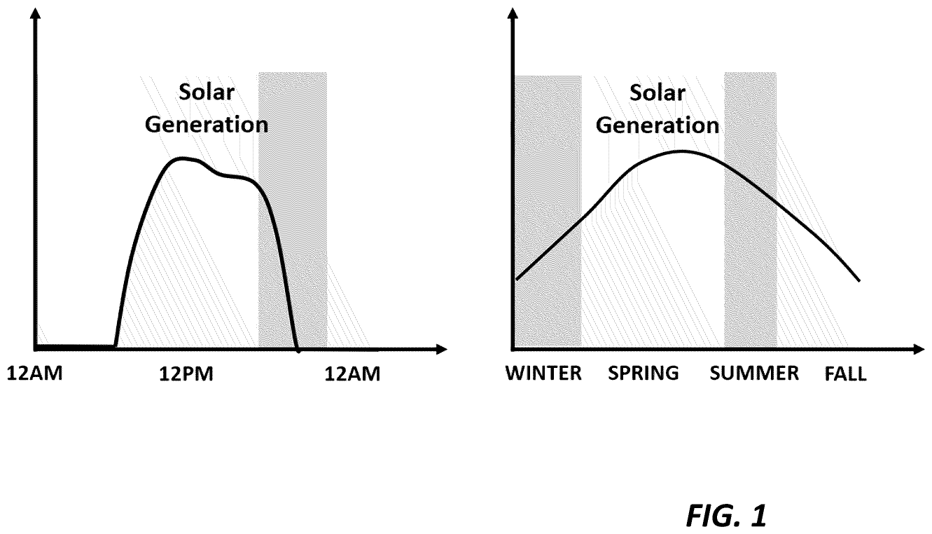

FIG. 1 shows a pair of plots illustrating generation patterns for U.S. solar source. As we noted previously and as may be observed from this figure, over the course of a typical day, generation from any particular solar source peaks in the early afternoon. Over the course of a year, generation from any particular solar generator typically peaks in summer. This variability can lead to inefficient use of power resources and unstable power delivery to users. There is a need for a system that can accurately predict solar power generation and optimize power generation and distribution processes.

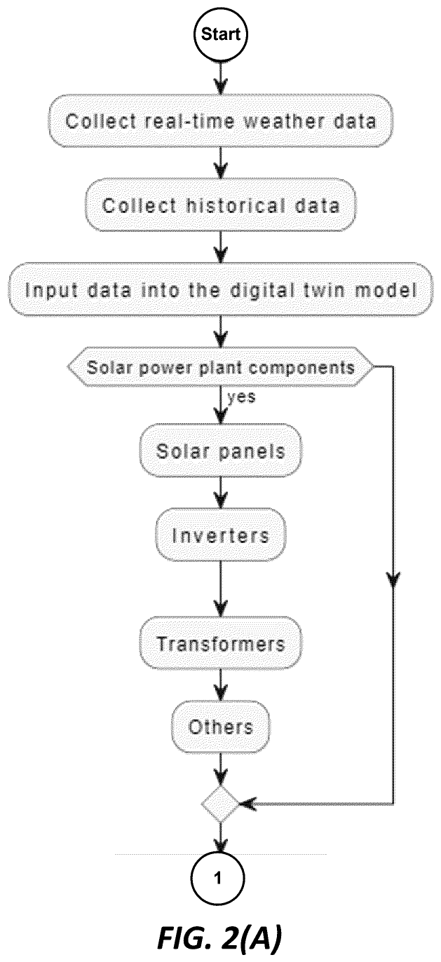

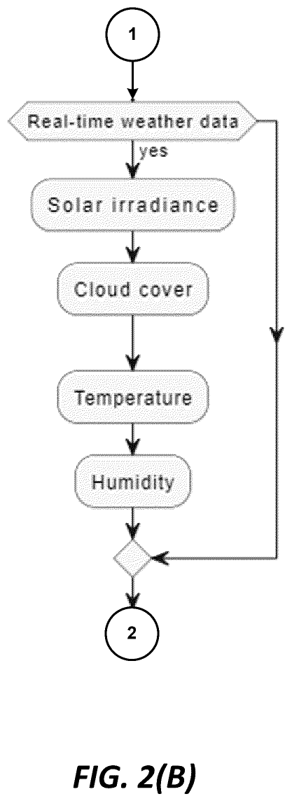

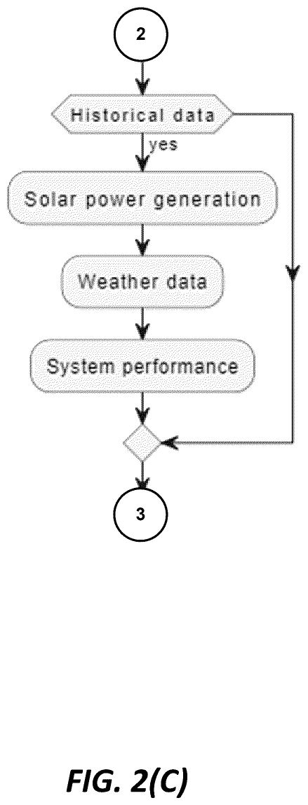

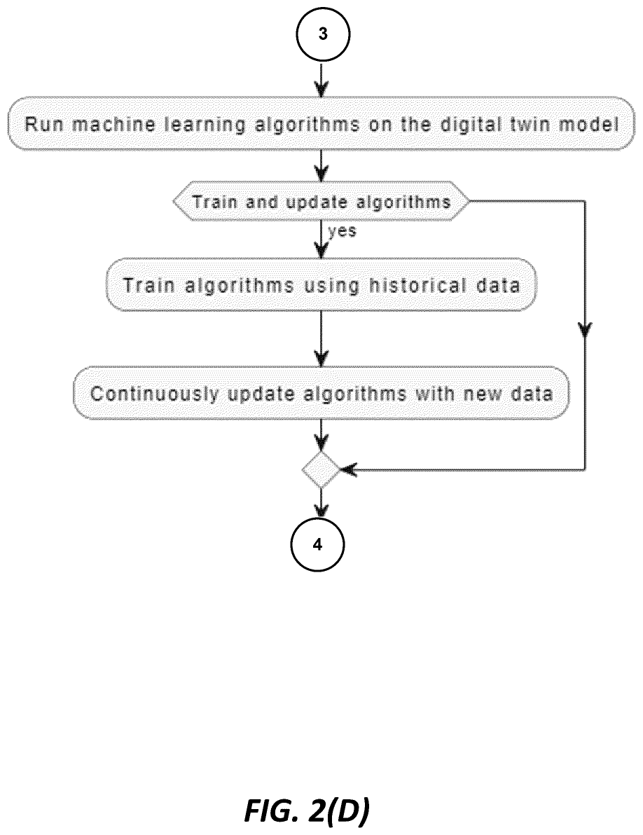

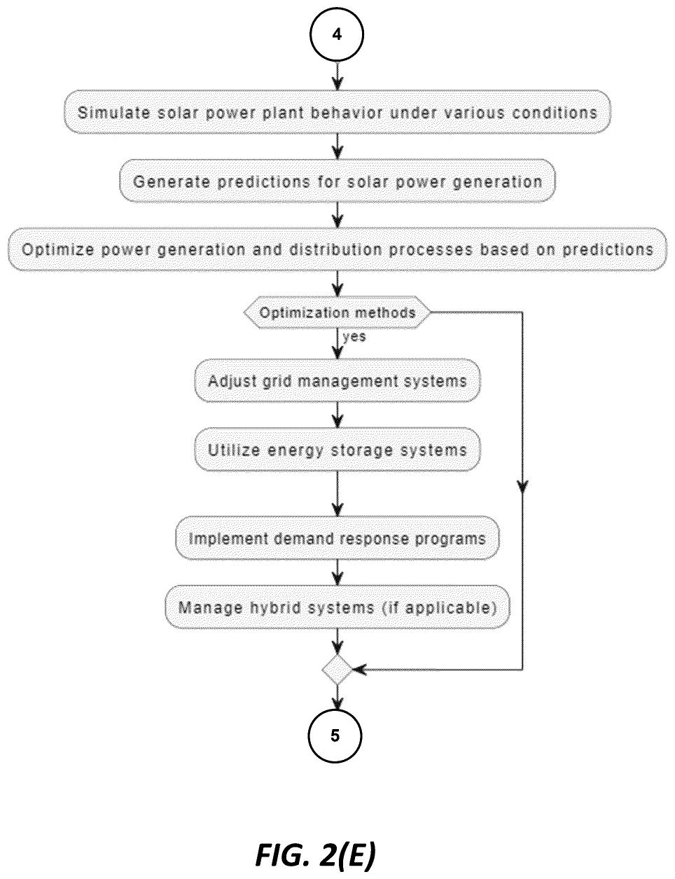

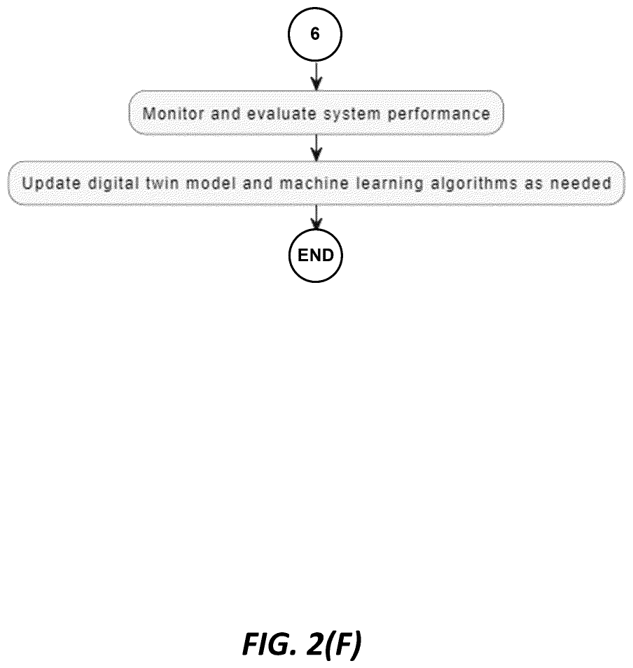

FIG. 2(A), FIG. 2(B), FIG. 2(C), FIG. 2(D), FIG. 2(E), and FIG. 2(F) are a series of schematic flow diagrams showing an illustrative overall method for optimizing power generation and distribution according to aspects of the present disclosure.

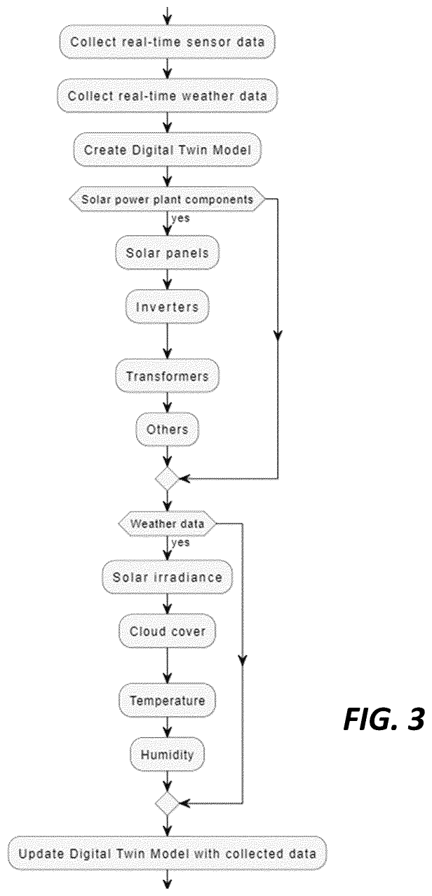

FIG. 3 is a schematic flow diagram showing an illustrative method for collecting real-time sensor data according to aspects of the present disclosure.

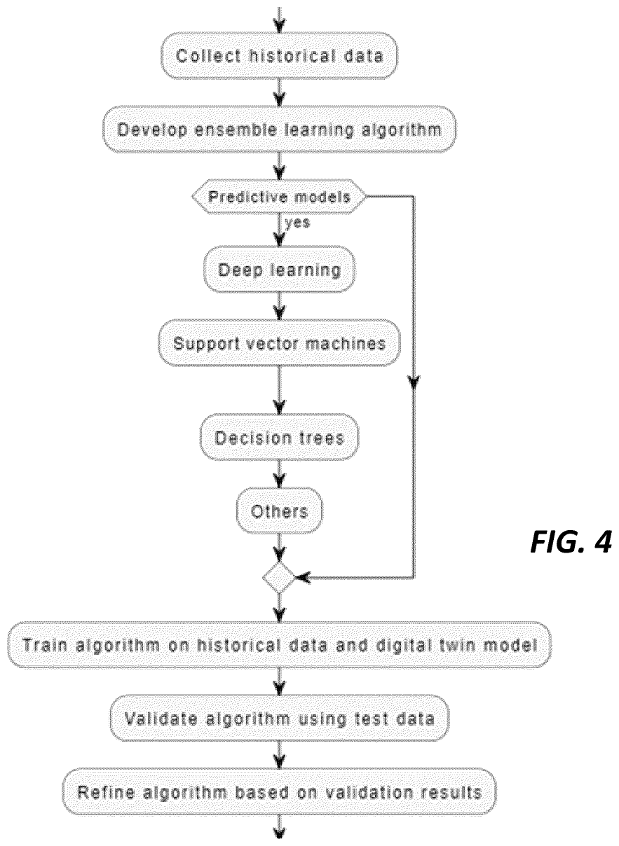

FIG. 4 is a schematic flow diagram showing an illustrative method for collecting historical data according to aspects of the present disclosure;

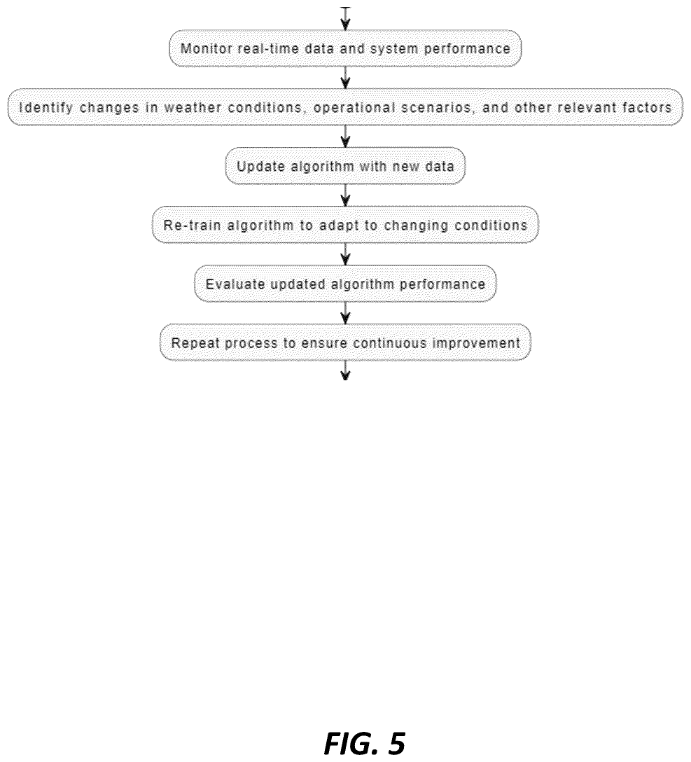

FIG. 5 is a schematic flow diagram showing an illustrative method for monitoring real-time data according to aspects of the present disclosure.

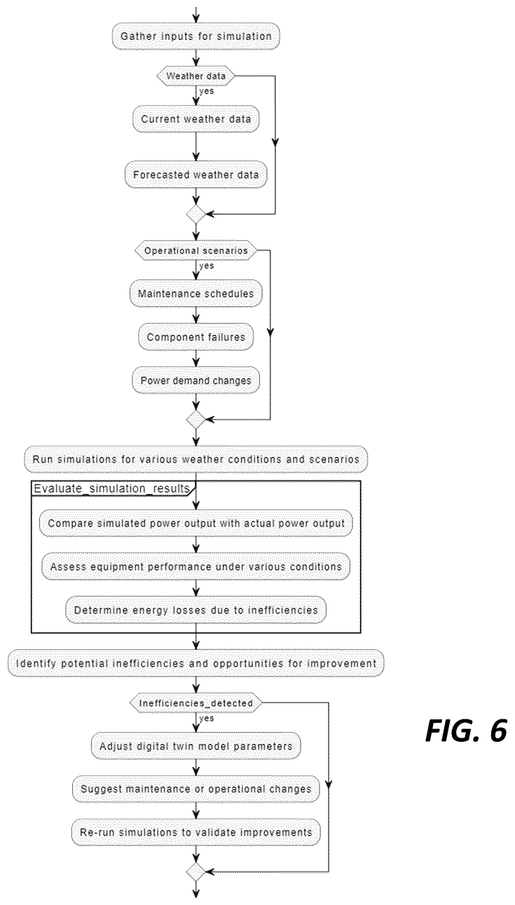

FIG. 6 is a schematic flow diagram showing an illustrative method for gathering simulation inputs and running same according to aspects of the present disclosure.

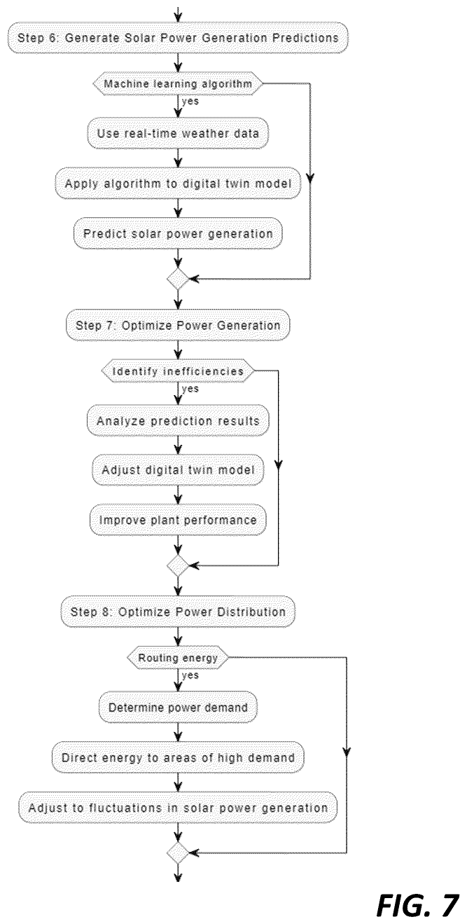

FIG. 7 is a schematic flow diagram showing an illustrative method for generating solar power predictions and optimizing power generation according to aspects of the present disclosure.

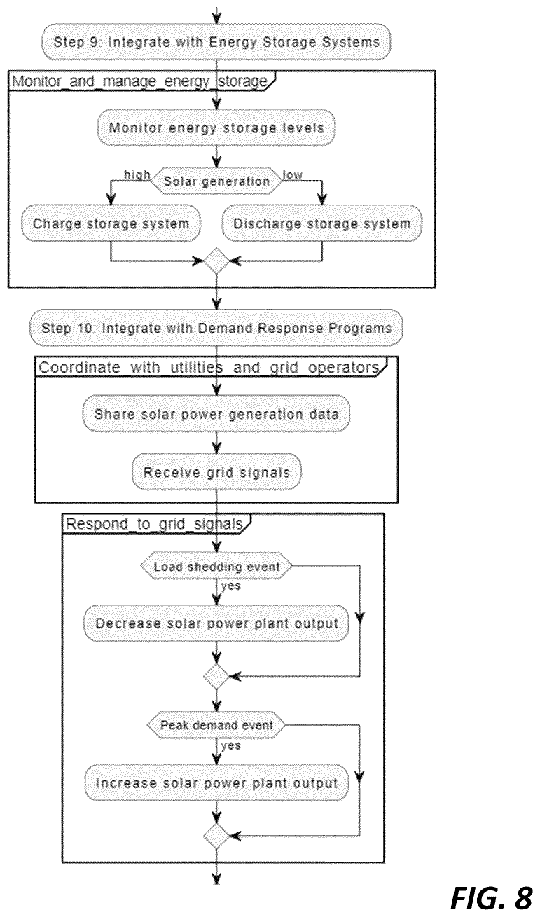

FIG. 8 is a schematic flow diagram showing an illustrative method for integrating energy with energy storage systems and demand response programs according to aspects of the present disclosure.

As may be observed from that series of flow diagrams and others, the following operations are performed.

### Step 1: Data Collection

Collect real-time weather data, such as solar irradiance, cloud cover, temperature, and humidity, as well as historical data on solar power generation, weather data, system performance, and maintenance schedules.

### Step 2: Update Digital Twin Model

Create a digital twin model, a virtual representation of the solar power plant, including solar panels, inverters, transformers, and other associated equipment. Update the model in real-time with sensor data from the actual solar power plant and the collected weather data.

### Step 3: Train Machine Learning Algorithm

Develop a machine learning algorithm that incorporates ensemble learning, combining multiple predictive models, such as deep learning, support vector machines, and decision trees. Train the algorithm on historical and real-time data from the digital twin model, weather data, solar power generation data, and other relevant factors.

### Step 4: Continuously Update Algorithm

Ensure the machine learning algorithm continuously learns from new data, adapting to changing conditions and improving its accuracy and efficiency in predicting solar power generation.

### Step 5: Simulate Plant Performance

Use the digital twin model to simulate the solar power plant's performance under various weather conditions and operational scenarios. This simulation helps identify potential inefficiencies and opportunities for improvement. The detailed steps are as follows:

Step 5.1: Gather inputs for simulation: Collect current and forecasted weather data, as well as operational scenarios and maintenance schedules, to be used as inputs for the digital twin model simulation.

Step 5.2: Run simulations for various weather conditions and scenarios: Using the gathered inputs, run simulations of the solar power plant performance under various weather conditions, maintenance schedules, component failures, and changes in power demand.

Step 5.3: Evaluate simulation results: Compare the simulated power output with the actual power output to assess the accuracy of the digital twin model. Assess the performance of individual equipment components under various conditions and determine energy losses due to inefficiencies in the system.

Step 5.4: Identify potential inefficiencies and opportunities for improvement: Analyze the simulation results to identify potential inefficiencies in the solar power plant operation or areas where improvements can be made.

Step 5.5: Adjust digital twin model parameters: If inefficiencies or opportunities for improvement are detected, adjust the parameters of the digital twin model to better reflect the actual performance of the solar power plant.

Step 5.6: Suggest maintenance or operational changes: Based on the analysis of the simulation results, suggest changes in maintenance schedules or operational practices to improve the overall efficiency and performance of the solar power plant.

Step 5.7: Re-run simulations to validate improvements: After adjusting the digital twin model parameters and suggesting maintenance or operational changes, re-run the simulations to verify that the improvements have a positive impact on the solar power plant's performance.

### Step 6: Generate Solar Power Generation Predictions

Apply the machine learning algorithm to the digital twin model to generate accurate predictions for solar power generation based on current and forecasted weather conditions and operational factors.

### Step 7: Optimize Power Generation

Analyze the predictions generated by the machine learning algorithm to identify potential inefficiencies in the solar power plant operation. Adjust the digital twin model and the actual solar power plant's operation to improve performance and increase overall power generation efficiency.

### Step 8: Optimize Power Distribution

Use the predictions from the machine learning algorithm to optimize power distribution, routing energy from solar generators to areas where it is needed most and adjusting to fluctuations in solar power generation.

### Step 9: Integrate with Energy Storage Systems

Integrate the digital twin model and machine learning algorithm with energy storage systems, such as batteries or pumped hydro storage, to stabilize power delivery by storing excess energy generated during peak solar production periods and releasing it during periods of low solar output.

Step 9.1: Monitor energy storage levels: Keep track of the current energy storage levels in the connected energy storage systems.

Step 9.2: Charge storage system: If solar power generation is high, charge the energy storage system with the excess generated power.

Step 9.3: Discharge storage system: If solar power generation is low, discharge the energy storage system to supply power to the grid or meet local demand.

### Step 10: Integrate with Demand Response Programs

Incorporate demand response programs that incentivize users to adjust their power consumption based on real-time solar power generation. This integration helps optimize power distribution, reduce the need for additional power sources, and better balance supply and demand on the grid.

Step 10.1: Share solar power generation data: Coordinate with utilities and grid operators by sharing real-time and forecasted solar power generation data.

Step 10.2: Receive grid signals: Receive grid signals from utilities and grid operators, which may include requests for load shedding or increased power output during peak demand events.

Step 10.3: Decrease solar power plant output: If a load shedding event is signaled, decrease the solar power plant output in accordance with the grid's requirements.

Step 10.4: Increase solar power plant output: If a peak demand event is signaled, increase the solar power plant output to help meet the increased demand on the grid.

### Step 11: Monitor and Evaluate System Performance

Regularly monitor and evaluate the performance of the digital twin model, machine learning algorithm, energy storage systems, and demand response programs to ensure they are effectively addressing the challenges posed by solar power generation variability.

### Step 12: Update and Refine the System

Continuously update the digital twin model, machine learning algorithm, and other components of the system as needed, incorporating new data, technology advancements, and insights gained from monitoring and evaluating system performance. This ongoing refinement ensures the system remains effective at addressing the challenges of solar power generation variability over time

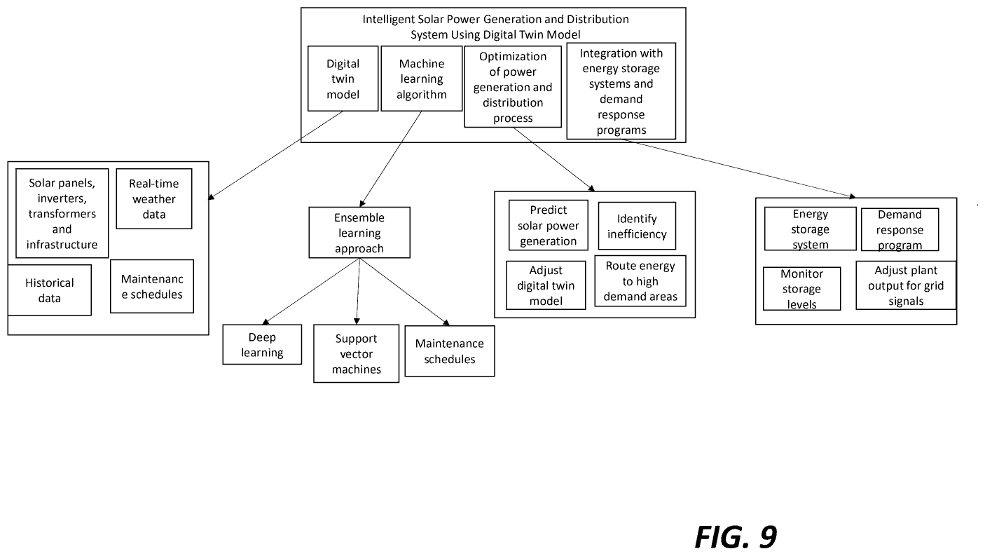

FIG. 9 is a schematic feature diagram showing illustrative features of systems and methods according to aspects of the present disclosure.

At this point we note that weather conditions can significantly impact energy trading because they influence both the supply and demand for energy commodities like electricity, natural gas, and heating oil. Energy traders closely monitor weather forecasts and adjust their trading strategies based on anticipated changes in supply and demand. By understanding how weather conditions can impact energy markets, traders can make more informed decisions and manage their risks more effectively.

Traditional weather forecasting methods in energy trading have several limitations, such as reduced accuracy for medium to long-term forecasts, limited spatial and temporal resolutions, and gaps in weather monitoring coverage. The current limitations of weather forecasts for energy traders:

Forecast accuracy: Weather forecasts become less accurate as the forecast horizon increases. While short-term forecasts (1-3 days ahead) tend to be relatively accurate, the accuracy of medium to long-term forecasts (7-14 days or beyond) is generally lower. This can make it challenging for energy traders to anticipate and manage weather-related risks over longer time horizons.

Spatial resolution: Weather forecasts are typically provided at a specific spatial resolution, which may not be granular enough to capture localized weather events or variations that could impact energy supply or demand. For example, a regional forecast might not accurately reflect the weather conditions at a specific wind farm or power plant.

Temporal resolution: The temporal resolution of weather forecasts, or the frequency at which forecast data is updated, can also be a limitation for energy traders. Higher temporal resolution forecasts (e.g., hourly) are generally more useful for short-term energy trading decisions, but they may not always be available for all locations or weather variables.

Complexity of weather data: Interpreting and integrating weather data into energy trading strategies can be complex, especially when considering multiple weather variables and their interactions with each other. Energy traders need to have a strong understanding of meteorology and the impact of weather on energy markets to make informed decisions.

These limitations can hinder energy traders from accurately anticipating and managing weather-related risks and effectively optimizing their trading strategies.

Systems and methods according to aspects of the present disclosure may advantageously integrate distributed fiber sensing data with existing weather forecasting data to enhance the accuracy and utility of weather forecasts for energy trading applications. The invention combines the complementary benefits of distributed fiber sensing technology and traditional weather data sources, along with novel machine learning algorithms, to address the limitations of existing weather forecasting methods in the energy trading market.

Distributed fiber sensing technology could help address some limitations of weather forecasting for energy traders, particularly in terms of spatial resolution and providing additional data sources. Distributed fiber optic sensors can monitor various parameters, such as temperature, strain, and vibration, along the entire length of an optical fiber. This technology could offer several benefits for weather monitoring and forecasting:

High spatial resolution: Distributed fiber sensing can provide data at the high spatial resolution, allowing for the detection of localized weather events or variations that may not be captured by traditional weather monitoring systems. This could help energy traders better understand the impact of weather on specific energy infrastructures or localized energy demand.

Real-time data: Distributed fiber sensing can deliver real-time data, enabling energy traders to monitor weather conditions and their impact on energy infrastructure continuously. This could improve situational awareness and help traders make more informed decisions about energy supply, demand, and pricing.

Enhanced infrastructure monitoring: By integrating distributed fiber sensing into energy infrastructure, such as power lines, pipelines, or wind turbines, energy traders can gain insights into the performance and health of these assets under varying weather conditions. This could help optimize maintenance schedules, identify potential issues before they become critical, and minimize downtime.

Improved weather data coverage: Deploying distributed fiber sensing networks in areas with limited weather monitoring coverage can help fill gaps in existing data sources, leading to more accurate and comprehensive weather forecasts.

Overall, our systems and methods comprise a network of distributed fiber optic sensors, data collection and processing units, and a central server. The distributed fiber optic sensors use existing telecom cables installed along energy infrastructure, such as power lines, pipelines, and wind turbines as sensor media, and are configured to collect real-time data on temperature, strain, and vibration. The data collection and processing units receive the raw data from the fiber optic sensors and preprocess the data for further analysis. The central server aggregates and analyzes the preprocessed fiber sensing data along with traditional weather forecasting data, applying machine learning algorithms to generate enhanced weather forecasts for energy trading applications.

The inventive features that contribute to solving the problem include at least the following.

Utilization of distributed fiber optic sensors: utilization of existing fiber optic cables along energy infrastructure like power lines, pipelines, and wind turbines that allows for real-time data collection on temperature, strain, and vibration. This information provides valuable insights into local weather conditions and infrastructure performance that traditional weather forecasting methods may not capture.

Integration of diverse data sources: The method and system combine data from distributed fiber optic sensors with traditional weather forecasting data using a weighted data fusion approach. This integration creates a more comprehensive and accurate representation of the weather, addressing limitations in traditional forecasting methods for energy trading applications.

Temporal and spatial alignment: The method involves aligning the fiber sensing data and traditional weather data in both time and space, ensuring that the combined dataset accurately represents the weather conditions and infrastructure performance at the right locations and times. This alignment is crucial for generating reliable and useful enhanced weather forecasts.

Data fusion techniques: The inventive method includes data fusion techniques that merge the temporally and spatially aligned fiber sensing data and traditional weather data while preserving unique information from each source and reducing redundancy and noise. This process leads to a more accurate and informative dataset for generating enhanced weather forecasts.

Machine learning algorithms: The use of machine learning algorithms allow the system to learn complex relationships between the integrated data and the target weather variables. By training the model on the integrated dataset, the system can generate enhanced weather forecasts that account for local weather conditions and energy infrastructure performance.

These inventive features work together to address the limitations of existing weather forecasting methods for energy trading applications. By providing more accurate, timely, and detailed information about weather conditions and their impact on energy supply, demand, and pricing, the inventive system and method help energy traders make more informed decisions and better manage weather-related risks in their trading strategies.

FIG. 10 is a schematic flow diagram showing an illustrative method for integrating distributed fiber optic sensing (DFOS) into our inventive systems and methods data according to aspects of the present disclosure.

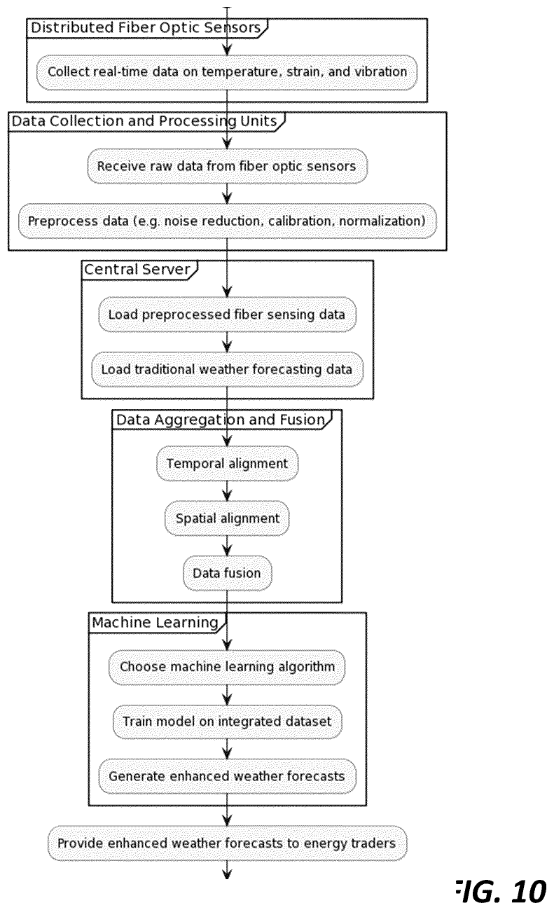

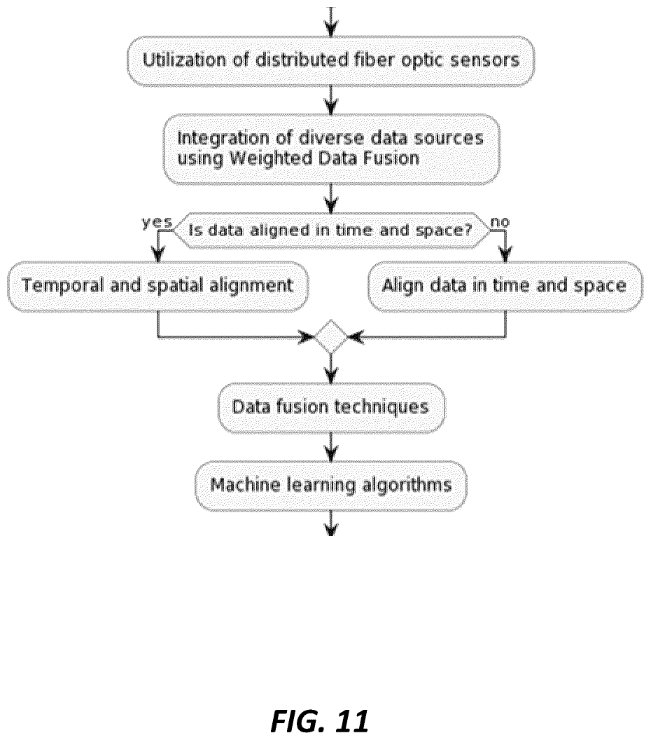

FIG. 11 is a schematic flow diagram showing an illustrative method for weather forecasting for systems and methods according to aspects of the present disclosure.

Our inventive illustrative weather forecasting systems and methods according to aspects of the present disclosure will operate according to the following steps.

### Step 1: Data Collection

Collect distributed fiber optic sensing data along energy infrastructure such as power lines, pipelines, and wind turbines to collect real-time data on temperature, strain, and vibration.

Acquire traditional weather forecasting data from public or commercial weather data sources, including temperature, humidity, wind speed, and precipitation forecasts.

### Step 2: Data Preprocessing

A. Fiber optic sensor data preprocessing:

Noise reduction: Apply filtering techniques such as moving average, median filter, or wavelet-based denoising to remove high-frequency noise from the raw fiber sensing data.

Calibration: Convert the raw fiber optic sensor measurements to physical quantities (e.g., temperature, strain, or vibration) using calibration data or conversion formulas.

Normalization: Normalize the calibrated fiber sensing data to ensure it is on a consistent scale. This can involve applying a min-max normalization (scaling data between 0 and 1) or z-score normalization (scaling data based on the mean and standard deviation).

B. Traditional weather forecasting data preprocessing:

Data quality check: Inspect the traditional weather data for inconsistencies, missing values, or outliers, and apply appropriate techniques to correct or remove these issues (e.g., imputation, outlier removal).

Spatial preprocessing: If the spatial resolution of the traditional weather data is different from that of the fiber sensing data, resample or interpolate the weather data to match the spatial resolution of the fiber sensing data. Techniques such as nearest neighbor interpolation, bilinear interpolation, or inverse distance weighting can be used for this purpose.

Temporal preprocessing: If the temporal resolution of the traditional weather data is different from that of the fiber sensing data, resample or aggregate the weather data to match the temporal resolution of the fiber sensing data. Techniques such as downsampling, upsampling, or moving averages can be used for this purpose.

### Step 3: Temporal and Spatial Alignment

Ensure that the fiber sensing data and traditional weather data are aligned in time by resampling, interpolating, or aggregating the data to a common temporal resolution.

Match the locations of the fiber sensing data points with the corresponding locations in the traditional weather data using geographic information system (GIS) techniques, such as nearest neighbor interpolation, bilinear interpolation, or inverse distance weighting. In this invention, we propose the following novel temporal alignment and spatial alignment techniques:

### A. Novel Temporal Alignment Techniques:

Dynamic Time Warping (DTW): Use the DTW algorithm to align the fiber sensing data and traditional weather data in time by finding an optimal match between the two time series that minimizes the overall distance, even in the presence of different sampling rates, time shifts, or time scaling.

Temporal Fusion Transformers (TFT): Employ a machine learning model, such as the TFT, to learn the temporal alignment between the fiber sensing data and traditional weather data based on their underlying patterns and relationships. This model can handle different sampling rates and capture complex temporal dependencies.

### B. Novel Spatial Alignment Techniques:

Graph-based spatial interpolation: Construct a graph using the fiber sensing data points and traditional weather data points, where the nodes represent the data points and the edges represent spatial relationships between them. Apply graph-based interpolation techniques (e.g., Graph Laplacian) to estimate the weather variables at the fiber sensing locations based on the spatial relationships captured by the graph. The following figure presents the Graph-based Spatial Interpolation Neural Network Architecture.

Spatial Deep Learning: Use a spatial deep learning model (e.g., Convolutional Neural Networks, Graph Convolutional Networks) to learn the spatial alignment between the fiber sensing data and traditional weather data based on the spatial patterns and relationships present in the data. These models can capture complex spatial dependencies and provide more accurate spatial alignment and interpolation.

### Step 4: Integration of Diverse Data Sources Using Weighted Data Fusion

Assign weights to both the distributed fiber optic sensor data and traditional weather forecasting data based on factors such as data accuracy, reliability, spatial and temporal resolution, and relevance to the target weather variables. Then, normalize the data from each source to ensure they are on the same scale and combine the normalized fiber optic sensor data and traditional weather data by calculating a weighted average of the values from each data source.

The weighted data fusion approach involves the following steps:

Assigning weights to data sources: Assign weights to both the distributed fiber optic sensor data and traditional weather forecasting data based on factors such as data accuracy, reliability, spatial and temporal resolution, and relevance to the target weather variables. Higher weights indicate greater confidence in the data source, while lower weights reflect less confidence.

Normalizing data: Normalize the data from each source to ensure they are on the same scale, facilitating direct comparison and fusion. This step can involve converting measurements to standardized units (e.g., the temperature in Celsius, wind speed in meters per second) and applying a min-max or z-score normalization method.

Weighted fusion: Combine the normalized fiber optic sensor data and traditional weather data by calculating a weighted average of the values from each data source. The weighted average is computed by multiplying the values from each data source by their assigned weights and dividing the sum by the total weight.

Weighted Data Fusion Formula:

Fused_Value=(Weight_Fiber*Value_Fiber+Weight_Weather*Value_Weather)/(Weight_Fiber+Weight_Weather)

where:

Fused_Value: The resulting combined value that represents the fusion of fiber optic sensor data and traditional weather data.

Weight_Fiber: The weight assigned to the fiber optic sensor data, based on factors such as data accuracy, reliability, spatial and temporal resolution, and relevance to the target weather variables. A higher weight indicates greater confidence in the data source.

Value_Fiber: The value of the fiber optic sensor data, such as a temperature or wind speed measurement.

Weight_Weather: The weight assigned to the traditional weather data, based on factors such as data accuracy, reliability, spatial and temporal resolution, and relevance to the target weather variables. A higher weight indicates greater confidence in the data source.

Value_Weather: The value of the traditional weather data, such as a temperature or wind speed measurement.

Post-fusion processing: Optionally, apply any post-fusion processing steps to further refine the fused dataset. These steps could include smoothing, outlier detection and removal, or feature extraction to highlight important patterns or relationships in the data. By employing the Weighted Data Fusion approach, the method and system integrate distributed fiber optic sensor data with traditional weather forecasting data in a principled and effective manner. This novel integration method helps create a more accurate and comprehensive representation of the weather, addressing the limitations of traditional forecasting methods and improving weather forecasts for energy trading applications.

### Step 5: Step 5: Enhanced Weather Forecast Generation with Novel Machine Learning Algorithms

In Step 5, we focus on analyzing the fused dataset generated in Step 4 to create enhanced weather forecasts. Machine learning algorithms, such as Graph Convolutional Networks (GCNs), Sequence-to-Sequence (Seq2Seq) Models with Attention Mechanisms, Multi-Task Learning (MTL) Models and Deep Probabilistic Models, are trained on the fused dataset to learn the complex relationships between the data and the target weather variables. By leveraging the machine learning models, the system generates enhanced weather forecasts that account for local weather conditions, energy infrastructure performance, and other factors captured by the fused dataset. Detailed steps are presented as follows:

The input layer takes in the fused dataset as input, which includes both fiber sensing data and traditional weather data.

The specific machine learning models used to train on the fused dataset are:

Graph Convolutional Networks (GCNs): GCNs are used to learn the spatial alignment between the fiber sensing data and traditional weather data based on the spatial patterns and relationships present in the data. GCNs can capture complex spatial dependencies and provide more accurate spatial alignment and interpolation.

Sequence-to-Sequence (Seq2Seq) Models with Attention Mechanisms: Seq2Seq Models with Attention Mechanisms are used to learn temporal dependencies between weather variables over time. These models can effectively capture the temporal relationships and patterns present in the data, leading to more accurate long-term weather forecasts.

Multi-Task Learning (MTL) Models: MTL Models are used to jointly learn multiple weather variables simultaneously. This approach can lead to improved performance and more accurate forecasts compared to models that learn each variable separately.

Deep Probabilistic Models: Deep Probabilistic Models are used to capture the uncertainty and variability present in weather data. These models can generate probabilistic forecasts that can be used to inform decision-making and risk management strategies for energy traders.

Each of these models is trained on the fused dataset to learn the complex relationships between the data and the target weather variables. The goal is to generate more accurate weather forecasts that account for local weather conditions, energy infrastructure performance, and other factors captured by the fused dataset.

The output layer generates enhanced weather forecasts based on the learned relationships between the data and target weather variables.

By following these steps, the system can generate enhanced weather forecasts that incorporate both fiber sensing data and traditional weather data, and account for local weather conditions, energy infrastructure performance, and other factors captured by the fused dataset.

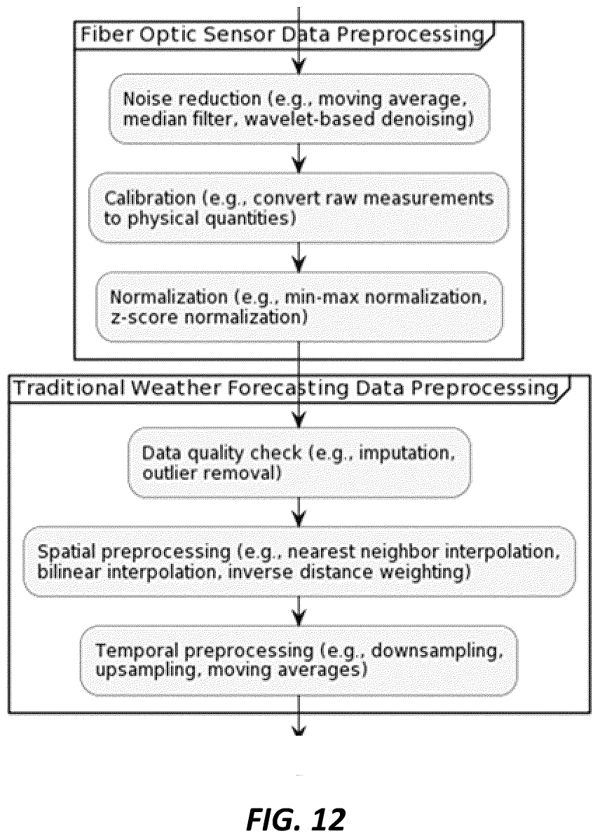

FIG. 12 is a schematic flow diagram showing an illustrative method for DFOS data preprocessing for systems and methods according to aspects of the present disclosure.

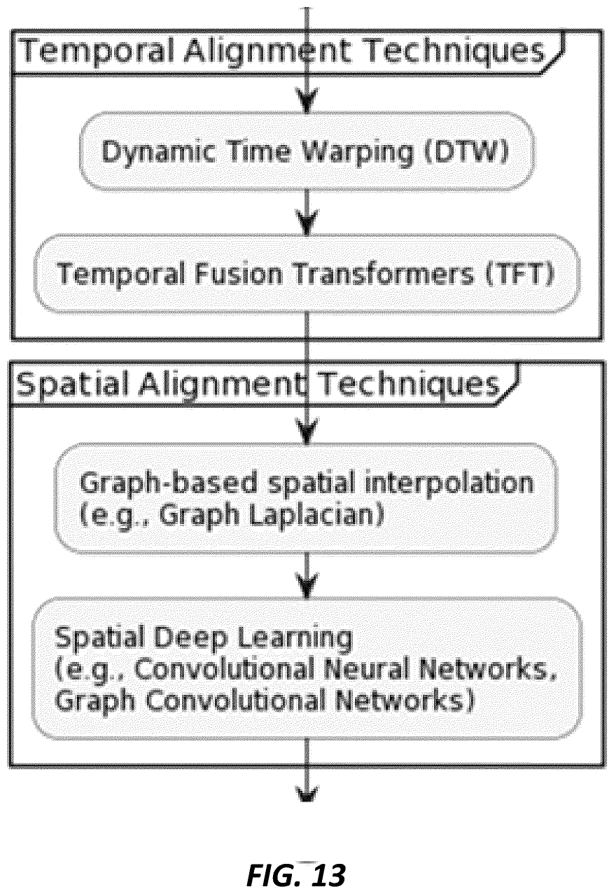

FIG. 13 is a schematic flow diagram showing an illustrative method for temporal and spatial alignment for systems and methods according to aspects of the present disclosure.

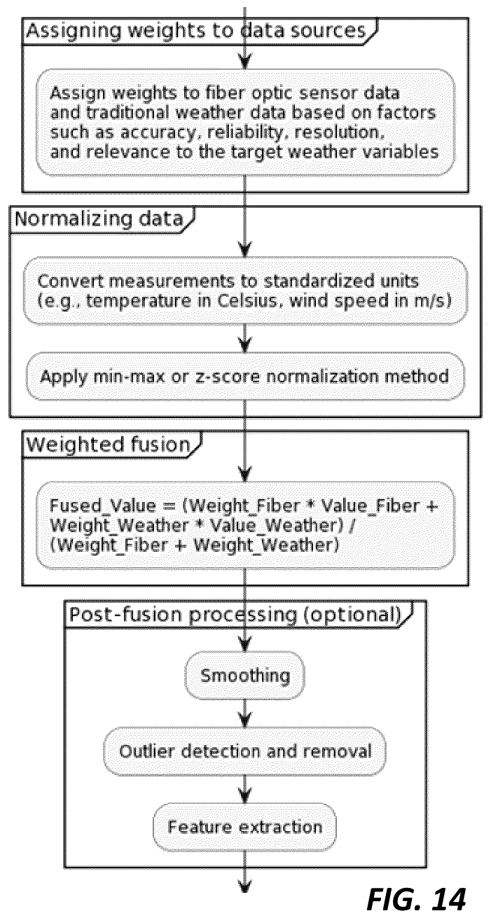

FIG. 14 is a schematic flow diagram showing an illustrative weighted data fusion method for systems and methods according to aspects of the present disclosure.

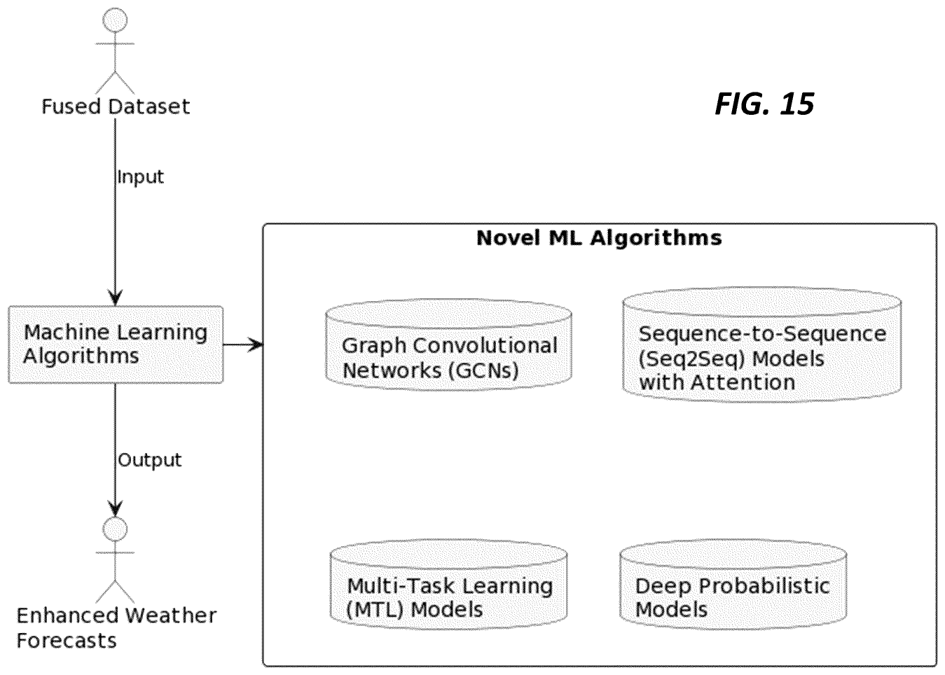

FIG. 15 is a schematic block diagram showing an illustrative arrangement of a system according to aspects of the present disclosure.

At this point we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

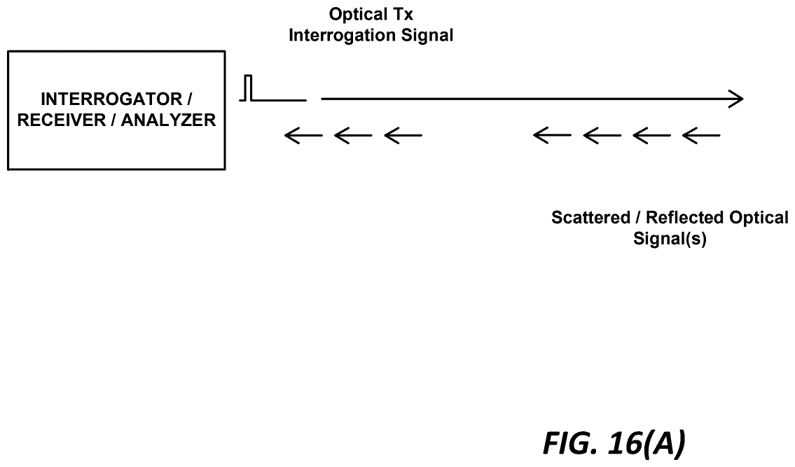

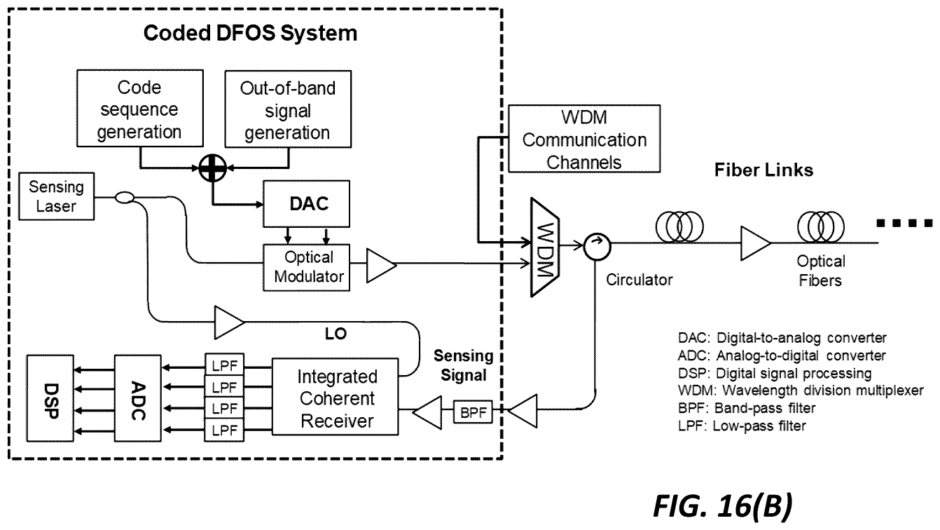

FIG. 16(A) and FIG. 16(B) are schematic diagrams showing an illustrative prior art uncoded and coded DFOS systems.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

A schematic diagram illustrating the generalized arrangement and operation of a distributed fiber optic sensing system that may advantageously include artificial intelligence/machine learning (AI/ML) analysis is shown illustratively in FIG. 16(A). With reference to FIG. 16(A), one may observe an optical sensing fiber that in turn is connected to an interrogator. While not shown in detail, the interrogator may include a coded DFOS system that may employ a coherent receiver arrangement known in the art such as that illustrated in FIG. 16(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DVS allows for continuous monitoring over long distances, but instead of measuring temperature, it measures vibrations and sounds along the fiber.

DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As the technology continues to develop, DAS/DVS is expected to become even more widely used in various fields where continuous and sensitive acoustic/vibration monitoring is crucial.

With the above in mind, we note that distributed fiber optics sensing (DFOS) continues to gain more interest as technology advances to use existing telecom fiber network for various sensing applications, such as traffic monitoring, public safety surveillance, road condition monitoring, and so on. Backscattered fiber sensing, including Rayleigh backscattering for distributed acoustic sensing (DAS), Raman backscattering for distributed temperature sensing (DTS), and Brillouin optical time domain reflectometer (BOTDR) for fiber strain and temperature sensing, are widely deployed and have tens of kilometers sensing distance.

While we have presented our inventive concepts and description using specific examples, our invention is not so limited. Accordingly, the scope of our invention should be considered in view of the following claims.

1. A computer-implemented, solar power generation method comprising:
by the computer:
collect real-time weather data;
update, using the collected real-time weather data, a digital twin model of a solar power plant;
train a machine learning algorithm using both historical data and the real-time weather data from the digital twin model of the solar power plant;
simulate, using the digital twin model of the solar power plant, the solar power plant performance; and
continuously update and refine the digital twin model and machine learning algorithm.

2. The solar power generation method of claim 1 wherein the real-time weather data comprises one or more of solar irradiance, cloud cover, temperature, and humidity.

3. The solar power generation method of claim 2 wherein the historical data comprises one or more of historical data on solar power generation, weather data, system performance and maintenance schedules.

4. The solar power generation method of claim 3 wherein the digital twin model is a virtual representation of the solar power plant.

5. The solar power generation method of claim 4 wherein the virtual representation of the solar power plant includes one or more solar panels, inverters, transformers.

6. The solar power generation method of claim 5 wherein the machine learning algorithm incorporates one or more of ensemble learning and a combination of predictive models including deep learning, support vector machines, and decision trees, and the training data includes the historical ad real-time data from the digital twin model, weather data, and solar power generation data.

7. The solar power generation method of claim 6 wherein the continuous updating and refining the digital twin model and machine learning algorithm includes adapting to changing conditions as indicated by the real-time data and improving accuracy and efficiency predicting solar power generation.

8. The solar power generation method of claim 1 wherein the simulation of the solar power plant performance includes collecting current and forecasted weather data as well as operational scenarios and maintenance schedules and using the collected weather data and operational scenarios and maintenance schedules as inputs for digital twin model simulations.

9. The solar power generation method of claim 8 wherein the simulation of the solar power plant performance includes running simulations for various component failures and changes inpower demand.

10. The solar power generation method of claim 9 wherein the simulation of the solar power plant performance includes comparing simulated power output of the solar power plant to an actual power output and determining from that comparison an accuracy of the digital twin model.
